(19) United States
(12) Patent Application Publication
(10) Pub. No.: US 2026/0043680 A1
(43) Pub. Date: Feb. 12, 2026

(54) Sensor housing and flange module for the sensor housing

(71) Applicant: Balluff GmbH, Neuhausen auf den Fildern (DE)

(72) Inventors: Tobias Rupp, Stuttgart (DE); David Salamunovic, Metzingen (DE)

(73) Assignee: Balluff GmbH, Neuhausen auf den Fildern (DE)

(21) Appl. No.: 19/268,725

(22) Filed: Jul. 14, 2025

(30) Foreign Application Priority Data
Aug. 9, 2024 (DE) 102024122873.3

(51) Int. Cl. G01D 11/24

(52) U.S. Cl. CPC G01D 11/245

(57) ABSTRACT

A flange module (10) for a sensor housing (30) has a bearing area and a substantially cylindrical connection element. An opening passes along the longitudinal axis of the connection element through the bearing area and through the connection element. A first seal runs around a lateral surface of the bearing area. A second seal runs on a contact region between the bearing area and the connection element around a lateral area of the connection element. At least one anti-rotation device is arranged on a side of the bearing area facing away from the connection element (12). The sensor housing (30) has an opening in which the bearing area of the flange module (10) is arranged. At least one anti-rotation device of the sensor housing (30) is engaged with at least one anti-rotation device of the flange module (10).

### CROSS REFERENCE TO RELATED APPLICATIONS

This application claims priority to German Patent Application No. 10 2024 122 873.3 filed Aug. 9, 2024, the disclosure of which is incorporated by reference herein in its entirety.

### FIELD

The present invention relates to a flange module. Furthermore, the present invention relates to a sensor housing which has the flange module.

### PRIOR ART

Magnetostrictive position measurement systems, which, for example, are used in industrial hydraulics, are often subjected to high pressures of several thousand bar during operation. Housings of such position measurement systems have to undergo more and more certifications. After such a housing has been screwed onto a cylindrical container, for example by means of a thread, it is tightened onto the container by means of an open-end wrench to create the required sealability. In this case, large torques of several hundred Nm are sometimes applied.

A plurality of different housing shapes are used for different application purposes. These housings are often made as a single-piece and therefore have to consist completely of the material that can withstand the high operating pressures and the high torques during tightening.

Therefore, such housings have high production costs. Furthermore, it is necessary to test the sealing concept of each housing at its connection point to a container and to have the housing certified for the provided pressure load.

It is an object of the present invention to provide differently dimensioned sensor housings, which meet the requirements that arise in industrial hydraulics with regards to their resistance to high pressures during operation and high torques during installation and which can be made cost-effectively and with minimal certification costs and effort.

### DISCLOSURE OF THE INVENTION

This object is solved in a first aspect of the invention by a flange module for a sensor housing. The invention is based on the finding that the pressures occurring in a container only act on a very small region of a sensor housing that has been manufactured as a single piece. The rest of the housing is pressure-free and therefore does not have to meet any particular requirements for pressure resistance.

The flange module has a bearing area, which is preferably annular. Particularly preferably, the bearing area is a circular disc with an opening, which is designed to bear on a surface of a sensor housing so that a pressure-sealed connection to the sensor housing is created. Furthermore, the flange module has a substantially cylindrical, in particular circular-cylindrical connection element. A connection element is understood to mean an element that is provided and designed to be inserted into an opening of a container, in the interior of which a measurement is to be carried out by means of a sensor arranged in the sensor housing. An opening passes along the longitudinal axis of the connection element through the bearing area and through the connection element. At least one first seal runs around a lateral surface of the bearing area. At least one second seal is arranged on a contact region between the bearing area and the connection element. It runs around a lateral surface of the connection element. This flange module can be used in differently dimensioned sensor housings. Therefore, it forms a pressure-sealed connection between a sensor and a container. In this case, the first seal creates a pressure-sealed connection between the flange module and the sensor housing. The second seal creates a pressure-sealed connection between the flange module and the container. It does not have to withstand any process pressures, but serves to seal against environmental influences. The bearing area and the connection element are designed as a single piece. In particular, they consist of a material which is selected from the group consisting of plastics, aluminium and steels. While the steel that can be used may fundamentally be a non-magnetic (austenitic) steel, preferably stainless steel is used. This means that the flange module can withstand high pressures. Particularly preferably, a high-pressure steel is used. This means that the flange module can withstand particularly high pressures. Furthermore, it is preferable that the flange module withstands tightening torques of 35 Nm. This ensures its usability in the PFB industry. Particularly preferably, it can withstand tightening torques of 100 Nm. Therefore, it can also be used in high-pressure regions.

The flange module has at least one anti-rotation device on a side of the bearing area facing away from the connection element. The anti-rotation device ensures that a play-free and deformation-free transmission of the torque to the flange module via suitable coupling geometry takes place when applying torque to the sensor housing. This means that the flange module can be designed without an external polygon so that, for example, an open-end wrench can be applied to the housing, and does not have to be applied to the flange module.

The first seal and the second seal are selected, preferably independently of each other, from the group consisting of an O-ring, a flat gasket and a press fit, in particular a metal-on-metal press fit.

Furthermore, it is preferable that the flange module has at least one fastening element on a side of the bearing area facing away from the connection element. The fastening element enables a fastening of the flange module to the sensor housing, so that unintended separation of the sensor housing and the flange module is eliminated. If the flange module has at least one anti-rotation device, torques acting on the housing are received by this anti-rotation device and not by the fastening element.

In some embodiments of the flange module, the connection element has a smooth lateral surface. In other embodiments, it is preferable that the connection element has an external thread, in order to be able to be screwed into an internal thread of a container.

The flange module preferably has a hollow rod on an end of the connection element facing away from the bearing area. Its hollow space is connected to the continuous opening in the connection element and in the bearing area. If the flange module is inserted into a sensor housing, it is possible to guide a measurement element of a sensor arranged in the sensor housing through the opening in the bearing area and in the connection element and into the rod. In particular, the rod can be connected to the connection element by means of welding or by means of soldering.

In particular, the substantially cylindrical connection element has a first region with a constant outer diameter. A second region, which is arranged between the first region and the hollow rod, preferably has an outer diameter which decreases from the first region in the direction of the hollow rod. Introduction of the connection element into an opening of a container is thus facilitated.

In a second aspect of the invention, the object is solved by the sensor housing. This has an opening, in which the bearing area according to the first aspect of the invention is arranged. In this case, a pressure-sealed connection is created between the inner edge of this opening and the lateral surface of the bearing area by means of the first seal. The sensor housing can in particular consist of any of the materials which are also suitable for making the bearing area and the connection element. The sensor housing can consist of the same material as the bearing area and the connection element or also of another material. Preferably, it consists of a material having a lower density than the flange module. This saves on weight in comparison to a conventional sensor housing which is made in a single piece from a single material. As the entire pressure load is absorbed by the flange module during operation, it is not necessary to have to certify the rest of the housing. Different shapes and sizes of the sensor housing can therefore be realised with a single flange module, which only has to be certified once.

The sensor housing has at least one anti-rotation device, which is engaged with at least one anti-rotation device of the flange module. The anti-rotation device of the flange module and the anti-rotation device of the sensor housing can be a single-edge coupling or a polygon coupling or a Sterling connection, for example.

It is preferable that the sensor housing has at least one fastening element, by means of which it is fastened to at least one fastening element of the flange module. The fastening elements of the flange module and of the sensor housing can be openings, in particular, through which in each case a screw is guided. In particular, further preferred fastening elements enable pressing or tilting, preferably by means of a plastic part of the bayonet lock, by means of flanging, by means of bending or by means of at least one union nut, or they enable an adhesive connection, a solder connection or a weld connection.

The sensor housing is designed as a polygonal surface, particularly preferably as a hexagonal surface, on its outer lateral surface at its end facing towards the flange module. This enables the housing to be tightened to a container by means of an open-end wrench, for example.

The sensor housing preferably has a sensor arranged in it, having a measurement element. The measurement element is guided through the opening of the flange module and thus through the bearing area and through the connection element. If the flange module has a hollow rod, the measurement element is guided into the hollow rod. The sensor may be, in particular, a magnetostrictive position sensor. For example, the latter can measure the position of a transducer, which can be designed, in particular, as a float gauge, along the hollow rod.

### BRIEF DESCRIPTION OF THE DRAWINGS

Exemplary embodiments of the invention are represented in drawings and are explained in more detail in the following description.

FIG. 1a, in an isometric representation, shows a flange module, a hollow rod and a sensor housing in an exemplary embodiment of the invention.

FIG. 1b shows a side view of the flange module, of the hollow rod and of the sensor housing according to FIG. 1a.

FIG. 2a shows a flange module connected to a hollow rod and a sensor housing in an isometric representation according to an exemplary embodiment of the invention.

FIG. 2b shows a side view of the flange module connected to a hollow rod and of the sensor housing according to FIG. 2a.

FIG. 3a shows an isometric representation of a sensor housing according to an exemplary embodiment of the invention, on which a flange module and a hollow rod are arranged.

FIG. 3b shows a side view of the sensor housing having a flange module and a hollow rod according to FIG. 3b.

FIG. 4 shows a sectional representation of a cylindrical container, on which a sensor housing according to an exemplary embodiment of the invention is arranged.

FIG. 5a shows an isometric representation of a flange module according to an exemplary embodiment of the invention.

FIG. 5b shows another isometric representation of the flange module according to FIG. 5a.

FIG. 6 shows an isometric representation of a sensor housing according to an exemplary embodiment of the invention.

FIG. 7 shows a partially sectioned representation of a sensor housing according to an exemplary embodiment of the invention, on which a flange module having a hollow rod is arranged.

### EXEMPLARY EMBODIMENTS THE INVENTION

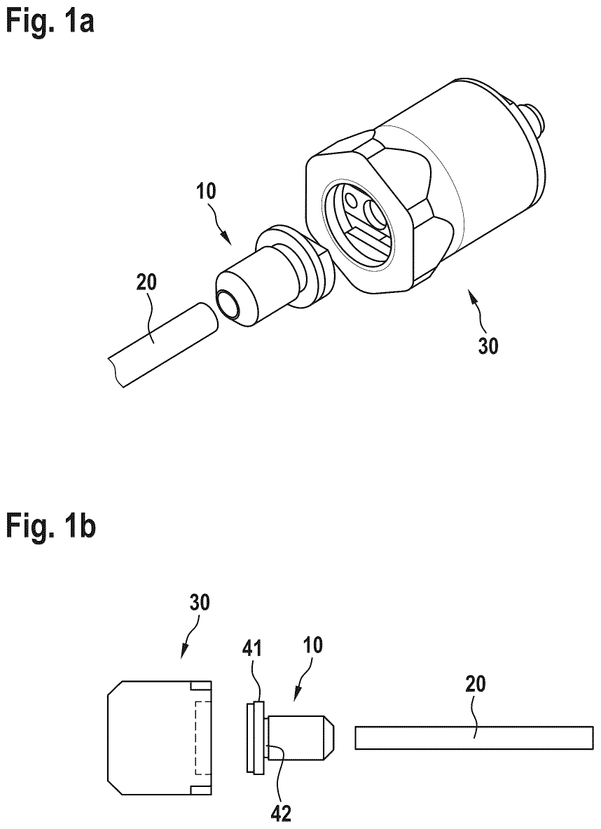

FIGS. 1a and 1b show a flange module 10, a hollow rod 20 and a sensor housing 30 in a first exemplary embodiment of the invention. While only one metallic base body of the flange module 10 is represented in FIG. 1a, it is represented in FIG. 1b with a first seal 41 and a second seal 42. The seals are each designed as a circumferential seal ring. The metallic base body of the flange module 10 and the hollow rod 20 in each case consist, for example, of high-pressure steel HP160. The sensor housing 30 consists of aluminium, for example.

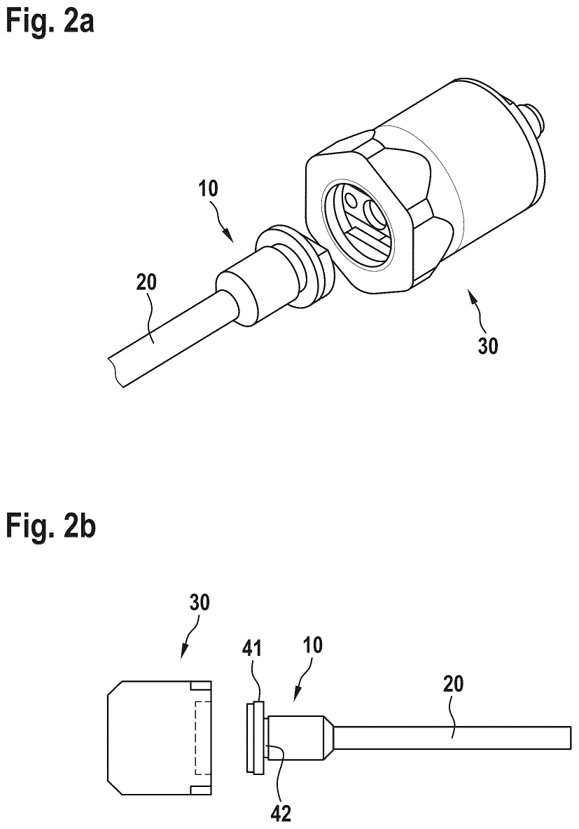

FIGS. 2a and 2b show how the hollow rod 20 can be attached to the flange module 10. It is attached by means of solder, for example. A continuous opening, which is fluidically connected to the interior of the hollow rod 20, runs along the longitudinal axis of the flange module 10. The hollow rod 20 is closed at its end facing away from the flange module 10.

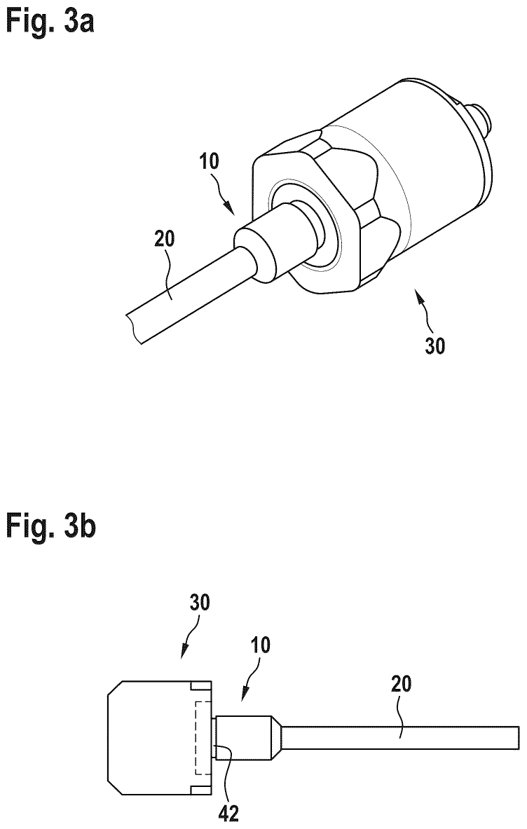

FIGS. 3a and 3b show how the flange module 10 has been inserted into an opening of the housing 30. The flange module 10, the hollow rod 20 and the sensor housing 30 form a fluid-tight unit when assembled.

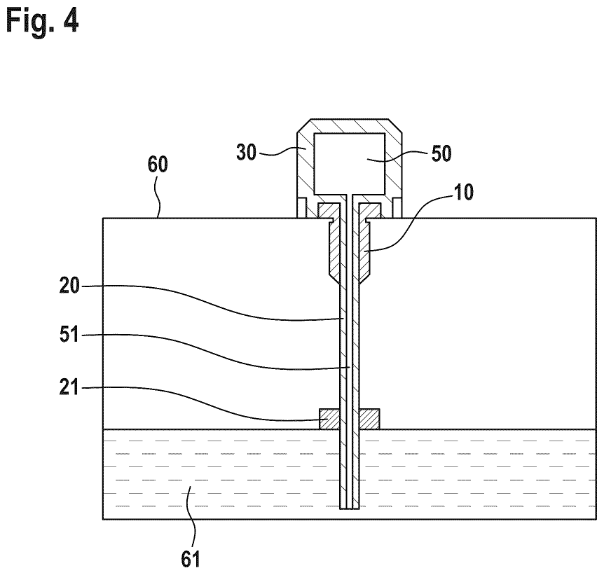

As is illustrated in FIG. 4, the sensor housing 30 can receive a magnetostrictive sensor 50, the measurement element 51 of which extends through the opening in the flange module 10 into the hollow rod 20. The hollow rod 20 and the flange module 10 are inserted into a cylindrical container 60 through an opening, which container is partially filled with a fluid 61. The housing is flange-mounted on the container 60 by means of an outer hexagon of the housing 30, such that the second seal 42 closes the connection between the sensor housing 30 and the container 60 in a seal-tight manner. A float gauge 21 surrounds the hollow rod 20 and floats on the fluid 61. It serves as a position sensor for the measurement element 51, so that the sensor 50 can determine the fill level of the fluid 61.

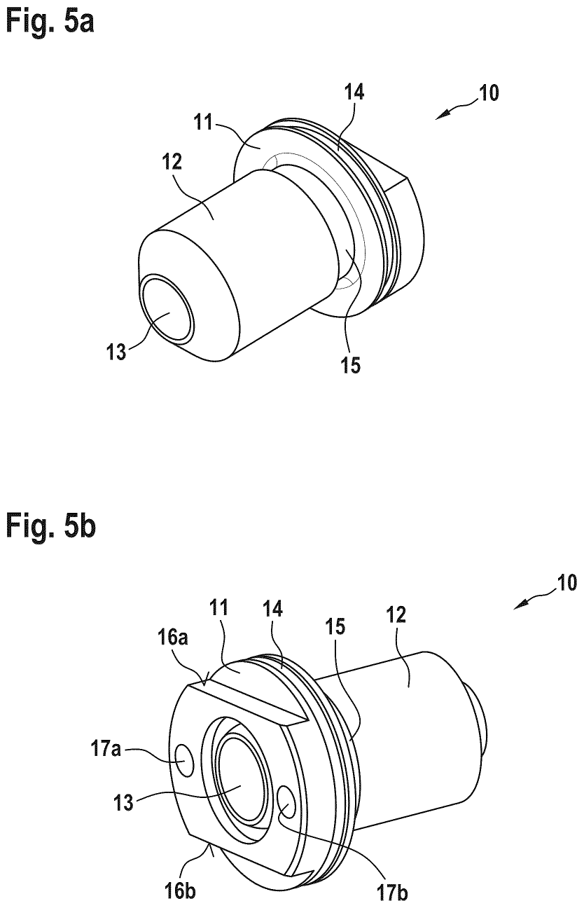

The flange module 10 is represented in FIGS. 5a and 5b. It has an annular bearing area 11 and a substantially cylindrical connection element 12. A circular cylinder-shaped opening 13 passes along the longitudinal axis of the connection element 12 through the connection element 12 and the bearing area 11. A first groove 14 runs around the lateral surface of the bearing area 11 and is provided for receiving the first seal 41. A second groove 15 runs directly adjacent to the bearing area 11 around the connection element 12 and is provided to receive the second seal 42. If the flange module 10 is inserted into the sensor housing 30, and the latter is flange-mounted to the container 60, the bearing area 11 forms a flanged connection to the upper side of the container 60. The second seal 42 comes to be in the opening of the container 60 and seals the latter. The bearing area 11 has two edge-shaped anti-rotation devices 16a, 16b on its side facing away from the connection element 12. Furthermore, said bearing area 11 has two blind hole-shaped openings on this side, which each have an internal thread and function as fastening elements 17a, 17b. They are located on a common straight line with the opening 13 passing through the flange module 10.

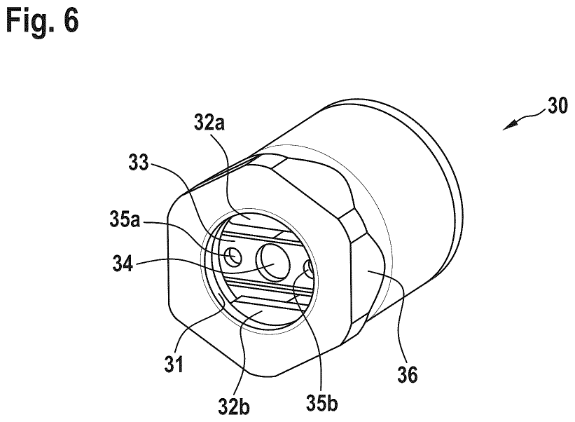

The sensor housing 30 is represented in FIG. 6. It has an opening 31 which is dimensioned such that the bearing area 11 can be inserted therein. In this case, the connection is sealed between the bearing area 11 and the sensor housing 30 by means of the first seal 41. The two anti-rotation devices 16a, 16b of the flange module 10 engage with two edge-shaped anti-rotation devices 32a, 32b of the sensor housing. Furthermore, the sensor housing has a web 33 running orthogonal to the opening 31. An opening 34 is located in the centre of the web, which opening is provided for the measurement element 51 to pass through. Two further openings 35a, 35b in the web serve as fastening elements and are positioned, when the bearing area 11 is inserted into the opening 31 due to the interaction of the anti-rotation devices 16a, 16b of the flange module 10 with the anti-rotation devices 32a, 32b of the sensor housing, such that they are congruent to the fastening elements 17a, 17b of the flange module 10.

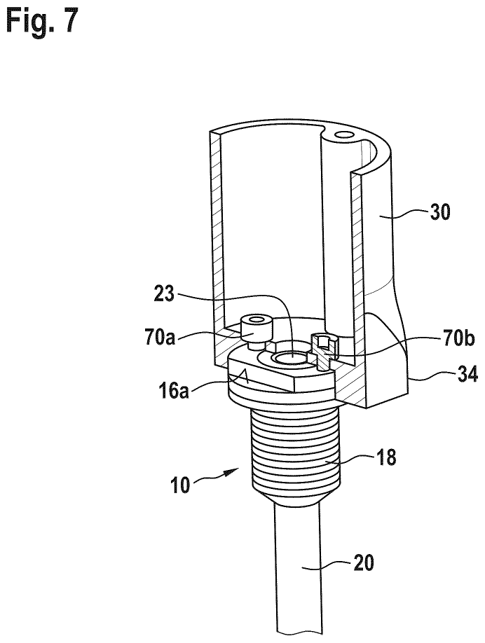

FIG. 7 shows how the flange module 10 and the sensor housing 30 can be connected permanently to each other by guiding two screws 70a, 70b through the fastening elements 32a, 32b of the sensor housing 30, designed as openings, such that they engage into the fastening elements 17a, 17b of the flange module 10. This is represented for a second exemplary embodiment of the invention. This differs from the first exemplary embodiment only in that the connection element 12 of the flange module 10 does not have a smooth lateral surface as in the first exemplary embodiment, but instead has an external thread 18 on its lateral surface. The connection element can be screwed using this external thread 18 into an opening of the container 60 which has an internal thread.

What is claimed is:

1. Flange module (10) for a sensor housing (30), having
a bearing area (11),
a substantially cylindrical connection element (12), wherein
an opening (13) passes along the longitudinal axis of the connection element (12) through the bearing area (11) and through the connection element (12),
at least one first seal (41), which runs around a lateral surface of the bearing area (11),
at least one second seal (42), which runs on a contact region between the bearing area (11) and the connection element (11) around a lateral surface of the connection element (12), and
at least one anti-rotation device (16a-b), which is arranged on a side of the bearing area (11) facing away from the connection element (12).

2. Flange module (10) according to claim 1, characterised in that it has at least one fastening element (17a-b) on a side of the bearing area (11) facing away from the connection element (12).

3. Flange module (10) according to claim 1, characterised in that the connection element (12) has an external thread (18).

4. Flange module (10) according to claim 1, characterised in that it has a hollow rod (20) on an end of the connection element (12) facing away from the bearing area (11).

5. Flange module (10) according to claim 1, wherein sensor housing (30), having an opening (31), in which the bearing area (11) of flange module (10) is arranged, and at least one anti-rotation device (32a-b), which is engaged with at least one anti-rotation device (16a-b) of the flange module (10).

6. Flange module (10) according to claim 5, wherein sensor housing (30) is characterised in that it has at least one fastening element (35a-b), by means of which it is fastened to at least one fastening element (17a-b) of the flange module (10).

7. Flange module (10) according to claim 5, wherein sensor housing (30) is characterised in that its outer lateral surface is designed as a polygonal surface (36) at its end facing towards the flange module.

8. Flange module (10) according to claim 5, wherein sensor housing (30) is characterised in that a sensor (50) having a measurement element (51) is arranged in said sensor housing, wherein the measurement element (51) is guided through the opening (13) of the flange module (10).
